(19) United States
(12) Patent Application Publication
(10) Pub. No.: US 2017/0352003 A1
(43) Pub. Date: Dec. 7, 2017

(54) TRANSPORTING GOODS USING A FLEET OF VEHICLES

(71) Applicant: National ICT Australia Limited, Eveleigh (AU)

(72) Inventors: Francesco Bertoli, Alexandria (AU); Philip Kilby, Alexandria (AU); Tommaso Urli, Alexandria (AU)

(21) Appl. No.: 15/615,054

(22) Filed: Jun. 6, 2017

(30) Foreign Application Priority Data
Jun. 6, 2016 (AU) 2016902186

(51) Int. Cl. G06Q 10/08; G06Q 10/04

(52) U.S. Cl. CPC G06Q 10/0875; G06Q 10/04

(57) ABSTRACT

This disclosure relates to transporting goods using a fleet of vehicles that is optimised. A processor solves a linear program to optimise a cost value by selecting one of multiple fleet configuration candidates comprising a number and type of vehicles that meet a transport demand at minimum cost. The linear program comprises constraints associated with multiple days. The processor then determines for one of the multiple days a further fleet configuration candidate based on an output of solving the linear problem and adds the further fleet configuration candidate to the multiple fleet configuration candidates by including an additional corresponding column into the linear program. The steps of solving the linear program, determining a further fleet configuration candidate and adding the further fleet configuration candidate to the multiple fleet candidates are then repeated until a termination condition is met.

### TECHNICAL FIELD

This disclosure relates to transporting goods using a fleet of vehicles that is optimised.

### BACKGROUND ART

Current computers have processors that can perform a certain number of operations per second and memories that can store a certain amount of data at any one time. This also applies to super computers. As a result of this limitation of computer technology there are complex computing problems that would take years to solve even on the most powerful computers. Further, the digital specification of those complex problems may be too large to be stored on memory. This means that using current computer technology, there is a limitation on the complexity of problems that can be solved optimally.

Transporting goods using a fleet of vehicles is such a complex problem. Efficient transportation is a fundamental component of a nation's economy, accounting for a significant fraction of the total cost of products. In order to stay competitive, particularly in the context of a global and connected market, companies are therefore pressured to reduce their transportation expenses by making smarter use of the available resources, e.g., fleets and warehouses. Of foremost importance, in this regard, are the decision made at the strategical (long-term) and tactical (mid-term) levels, as they determine how the day-to-day operations can be carried out, which in turn reflects on the efficiency of the system.

One problem encountered with transportation is fleet design, i.e., the problem of determining the size and composition of a fleet of vehicles to carry out the daily delivery operations of a company. The problem can be informally stated as follows, given
1. the demand of a set of customers over a period of time,
2. a catalogue of truck types with different characteristics, e.g., capacity, running costs, compartments, etc., and
3. a model describing the constraints and costs incurred in running the delivery operations,
   identify the most efficient fleet to satisfy the demand in the long term.

One of the main problems with fleet design is that due to limitations of computer technology scenarios with a practical size are impossible to calculate in a practical time. Therefore, there is a need for an improvement of the efficiency of available computer technology. Such an improvement would allow the solving of practical problems on currently available computers, which has been difficult due to the limitations in computer technology. The result, would be more accurate, available quicker and would use less computing power than existing solutions.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

A transport system comprises:
one or more sender warehouses storing goods at respective sender locations;
multiple receiver warehouses for storing the goods at respective receiver locations;
a data collection server to receive demand data for multiple days, convert the demand data into a data format suitable for one of multiple vehicle routing engines, and store the demand data on a datastore;
a communication network to transmit the demand data from the data collection server to a processing server;
a processing server to retrieve the demand data and to determine an optimised fleet configuration comprising a number and type of vehicles based on the demand data for multiple days, the processing server comprising a linear program solver and the one of multiple vehicle routing engines, the processing server being configured
   to activate the linear program solver to optimise a cost value by selecting one of multiple fleet configuration candidates that meet a transport demand represented by the demand data, the linear program comprising constraints associated with multiple days;
   to activate the one of multiple vehicle routing engines to determine based on the demand data in the suitable data format for one of the multiple days a further fleet configuration candidate based on an output of the linear program solver;
   to add the further fleet configuration candidate to the multiple fleet configuration candidates by including an additional corresponding column into the linear program;
   to repeat the steps of solving the linear program, determining a further fleet configuration candidate and adding the further fleet configuration candidate to the multiple fleet candidates until a termination condition is met; and
a fleet of vehicles according to the selected one of multiple candidate fleet configurations to transport the goods from the sender locations to the receiver locations according to the demand data.

A computer implemented method for determining an optimised fleet configuration comprises:
solving a linear program to optimise a cost value by selecting one of multiple fleet configuration candidates comprising a number and type of vehicles that meet a transport demand at minimum cost, the linear program comprising constraints associated with multiple days;
determining for one of the multiple days a further fleet configuration candidate based on an output of solving the linear problem;
adding the further fleet configuration candidate to the multiple fleet configuration candidates by including an additional corresponding column into the linear program;
repeating the steps of solving the linear program, determining a further fleet configuration candidate and adding the further fleet configuration candidate to the multiple fleet candidates until a termination condition is met; and
in response to the termination condition being met outputting the selected one of multiple fleet candidates as the optimised fleet configuration.

It is an advantage that adding candidates that are determined for one day allows the optimisation of problems that would otherwise be intractable due to the large number of constraints. The above method adds columns consecutively until the termination condition is met, which means that in most cases the entire problem considering all columns does not need to be solved.

The method may further comprise performing column generation comprising a master problem and a sub-problem, the linear program being the master problem and determining for one of the multiple days a further fleet configuration candidate being the sub-problem.

Determining for one of the multiple days a further fleet configuration candidate may comprise determining a fleet configuration that solves a vehicle routing problem for the one of the multiple days.

Determining for one of the multiple days a further fleet configuration candidate may comprise determining a cost coefficient for the further fleet configuration candidate.

Determining the cost coefficient may comprise optimising a reduced cost associated with the further fleet configuration candidate.

The linear problem may comprise the cost coefficient of the further fleet configuration candidate.

The output of solving the linear problem may be a value of a dual variable of the linear problem.

The dual variable of the linear problem may be indicative of the costs of the vehicles.

The linear problem may comprise constraints to meet the transport demand.

The linear problem may comprise a binary decision variable for each fleet configuration candidate indicative of whether that fleet configuration candidate is selected.

Each of the multiple fleet configuration candidates may comprise a number of vehicles for each of multiple vehicle types.

The linear problem may comprise one or more columns associated with vehicles in a prior fleet and one or more columns associated with buying vehicles or selling vehicles or both.

The linear problem may comprise one or more columns associated with hiring vehicles on one or more of the multiple days.

Determining the further fleet configuration candidate may comprise determining a routing of vehicles that meets a demand for the further fleet configuration candidate.

The method further may comprise determining for each route whether to buy or hire a vehicle for that route.

Determining the routing and repeating the step of determining a further fleet configuration candidate may comprise determining multiple routings for respective fleet configuration candidates and the method further comprises selecting one of the multiple routings based on the selected one of multiple fleet candidates.

Determining the further fleet configuration candidate may comprise performing a branch and price method.

The branch and price method may branch on a number of vehicles for each of multiple vehicle types.

Determining for one of the multiple days a further fleet configuration candidate may comprise selecting the one of the multiple days based on a score for each of the multiple days.

The score for each of the multiple days may be based on a dual variable of the linear program.

Determining for one of the multiple days a further fleet configuration candidate may comprise activating one of multiple routing engines.

It is an advantage that a wide variety of routing engines can be used including engines that solve rich routing problems.

Software, when performed by a computer, causes the computer to perform the above method.

A computer system for determining an optimised fleet configuration comprises:
an input port to receive a transport demand for each of multiple days;
a processor
   to solve a linear program to optimise a cost value by selecting one of multiple fleet configuration candidates comprising a number and type of vehicles that meet the transport demand, the linear program comprising constraints associated with multiple days,
   to determine for one of the multiple days a further fleet configuration candidate based on an output of solving the linear problem,
   to add the further fleet configuration candidate to the multiple fleet configuration candidates by including an additional corresponding column into the linear program, and
   to repeat the steps of solving the linear program, determining a further fleet configuration candidate and adding the further fleet configuration candidate to the multiple fleet candidates until a termination condition is met; and
an output port to output the selected one of multiple fleet candidates as the optimised fleet configuration in response to the termination condition being met.

Optional features described of any aspect of method, computer readable medium or computer system, where appropriate, similarly apply to the other aspects also described here.

### BRIEF DESCRIPTION OF DRAWINGS

An example will be described with reference to

FIG. 1 illustrates a transport network.

FIG. 2 illustrates a computer system for determining an optimised fleet configuration.

FIG. 3 illustrates a method for determining an optimised fleet configuration.

FIG. 4 illustrates the total objective and relative fixed cost for both integer and linear restricted master problems plotted against the progression of iterations.

### BEST MODE FOR CARRYING OUT THE INVENTION

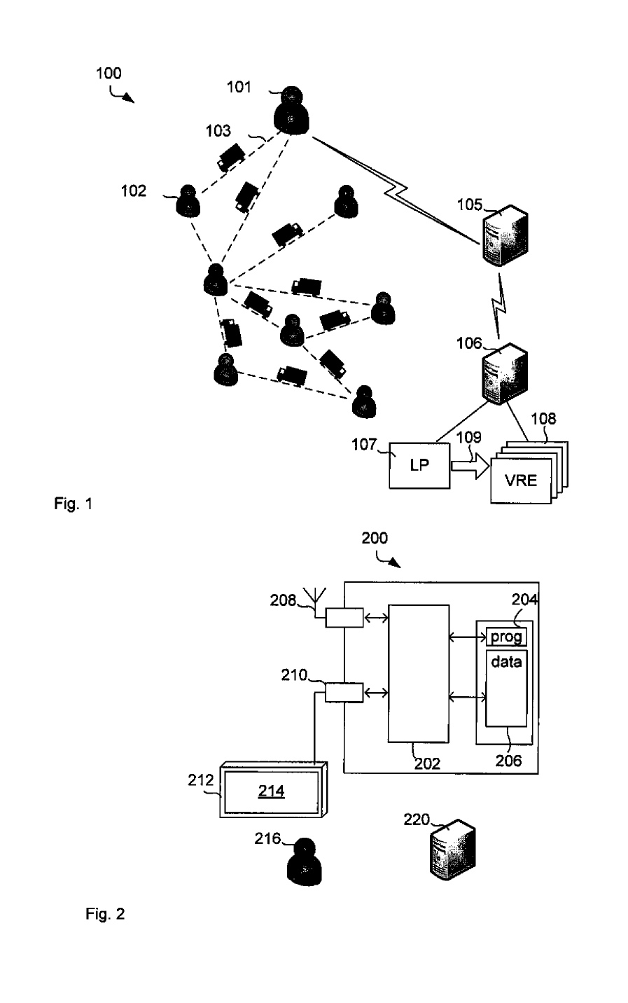

FIG. 1 illustrates a transport system 100 where a sender 101 delivers goods to multiple receivers, such as example receiver 102, over multiple transport links, such as example transport link 103. Each of the receivers has a demand for goods. The demand may specify a number or amount of the goods of a respective type and a time window when those goods arrive at the receiver, or many other constraints. The sender 101 can deliver the goods via a fleet of vehicles. It is in the interest of the sender to be able to easily configure this fleet vehicles to achieve efficient delivery of the goods at a minimum cost based on the demand of the receivers.

It is noted that the terms ‘sender’ and ‘receiver’ refer to processing centres, such as fulfilment centres, warehouses, depots, premises, parcel lockers and the like.

Transport system 100 further comprises a data collection server 105 and a processing server 106. The processing server 106 comprises a linear program solver 107 and multiple vehicle routing engines 108. The data collection server 105 receives demand data for multiple days, converts the demand data into a data format suitable for one of the multiple vehicle routing engines 108, and stores the demand data on a datastore. The processing server 106 retrieves the demand data and determines an optimised fleet configuration based on the demand data for multiple days as follows.

Processing server 106 activates the linear program solver 107 to optimise a cost value by selecting one of multiple fleet configuration candidates that meet a transport demand represented by the demand data. The linear program comprises constraints associated with multiple days. Processing server 106 further activates one of the multiple vehicle routing engines 108 to determine based on the demand data in the suitable data format for one of the multiple days a further fleet configuration candidate based on an output 109 of the linear program solver 107. Processing server 106 then adds the further fleet configuration candidate to the multiple fleet configuration candidates by including an additional corresponding column into the linear program.

Processing server 106 repeats the steps of solving the linear program, determining a further fleet configuration candidate and adding the further fleet configuration candidate to the multiple fleet candidates until a termination condition is met.

The transport system 100 also comprises a fleet of vehicles according to the candidate fleet configuration selected by processing server 106 and as indicated by the truck symbols in FIG. 1. The fleet of vehicles transports the goods from the sender locations to the receiver locations according to the demand data.

Since the further fleet configuration candidates are incrementally added to the master problem, it is possible to solve problems of a size that would previously been impossible to solve due to limitations of computer technology. In particular, the limited computing power and memory size of processing server 106 means that previous approaches would have taken years to solve if at all possible.

It is noted that data collection server 105 and processing server 106 may be hosted on the same physical machine as separate virtual machines, separate processes on the same machine or function calls within the same process, or other ways. The data collection server 105 and processing server 106 communicate via a communication network, such as the internet, an intranet, USB, firewire, internal PCI bus network, middleware messaging layer, pointers, variables or other communication means.

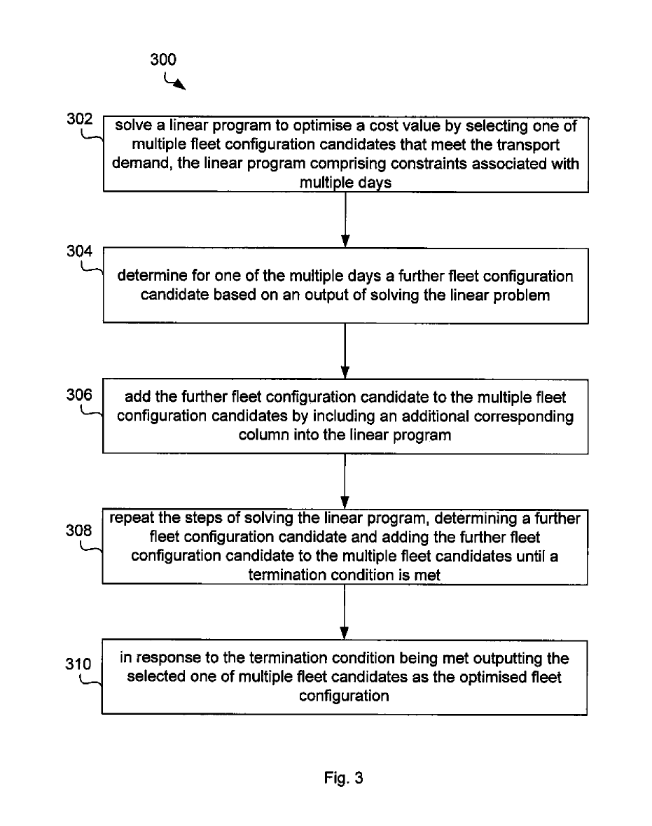

FIG. 2 illustrates a computer system 200 for determining an optimised fleet configuration. Computer system 200 may be part of the processing server 106 in FIG. 1. The computer system 200 comprises a processor 202 connected to a program memory 204, a data memory 206, a communication port 208 and a user port 210. The program memory 204 is a non-transitory computer readable medium, such as a hard drive, a solid state disk or CD-ROM. Software, that is, an executable program stored on program memory 204 causes the processor 202 to perform the method in FIG. 3, that is, the processor 202 performs the following steps. The processor 202 solves a linear program to optimise a cost value by selecting one of multiple fleet configuration candidates that meet a transport demand at minimum cost. The linear program comprises constraints associated with multiple days. The processor 202 determines for one of the multiple days a further fleet configuration candidate based on an output of solving the linear problem. The processor 202 adds the further fleet configuration candidate to the multiple fleet configuration candidates by including an additional corresponding column into the linear program. The processor 202 repeats the steps of solving the linear program, determining a further fleet configuration candidate and adding the further fleet configuration candidate to the multiple fleet candidates until a termination condition is met. In response to the termination condition being met, the processor 202 outputs the selected one of multiple fleet candidates as the optimised fleet configuration.

The processor 202 may then store the optimised fleet configuration on data store 206, such as on RAM or a processor register. Processor 202 may store the optimised fleet configuration as a text file, XML or JSON file on as database records. Processor 202 may also send the determined optimised fleet configuration via communication port 208 to a server or a client device.

The processor 202 may receive data, such as a current fleet configuration and/or demands data for sending of goods, from data memory 206 as well as from the communications port 208 and the user port 210, which is connected to a display 212 that shows a visual representation 214 of the optimised fleet configuration to a user 216. In one example, the processor 202 receives demand data from senders or receivers of goods or from an order management computer via communications port 208, such as by using a Wi-Fi network according to IEEE 802.11. The Wi-Fi network may be a decentralised ad-hoc network, such that no dedicated management infrastructure, such as a router, is required or a centralised network with a router or access point managing the network.

In one example, the processor 202 receives and processes the current fleet or demand data in real time. This means that the processor 202 determines an optimal fleet configuration every time updated demand data is received and performs calculations to provide an updated optimal fleet configuration.

Although communications port 208 and user port 210 are shown as distinct entities, it is to be understood that any kind of data port may be used to receive data, such as a network connection, a memory interface, a pin of the chip package of processor 202, or logical ports, such as IP sockets or parameters of functions stored on program memory 204 and executed by processor 202. These parameters may be stored on data memory 206 and may be handled by-value or by-reference, that is, as a pointer, in the source code.

The processor 202 may receive data through all these interfaces, which includes memory access of volatile memory, such as cache or RAM, or non-volatile memory, such as an optical disk drive, hard disk drive, storage server or cloud storage. The computer system 200 may further be implemented within a cloud computing environment, such as a managed group of interconnected servers hosting a dynamic number of virtual machines.

It is to be understood that any receiving step may be preceded by the processor 202 determining or computing the data that is later received. For example, the processor 202 determines a current fleet configuration and stores the current fleet configuration in data memory 206, such as RAM or a processor register. The processor 202 then requests the data from the data memory 206, such as by providing a read signal together with a memory address. The data memory 206 provides the data as a voltage signal on a physical bit line and the processor 202 receives the current fleet configuration via a memory interface.

It is to be understood that throughout this disclosure unless stated otherwise, nodes, edges, graphs, solutions, variables, models, constraints, problems and the like refer to data structures, which are physically stored on data memory 206 or processed by processor 202. Further, for the sake of brevity when reference is made to particular variable names this is to be understood to refer to values of variables stored as physical data in computer system 200.

FIG. 3 illustrates a method 300 as performed by processor 202 for determining an optimised fleet configuration. FIG. 3 is to be understood as a blueprint for the software program and may be implemented step-by-step, such that each step in FIG. 3 is represented by a function in a programming language, such as C++ or Java. The resulting source code is then compiled and stored as computer executable instructions on program memory 204.

It is noted that for humans performing the method 300 manually, that is, without the help of a computer, would be practically impossible. Therefore, the use of a computer is part of the substance of the invention and allows performing the necessary calculations that would otherwise not be possible due to the large amount of data and the large number of calculations that are involved.

The method 300 for determining an optimised fleet configuration comprises the following steps. At step 302, the processor 202 solves a linear program to optimise a cost value by selecting one of multiple fleet configuration candidates that meet a transport demand at minimum cost. The linear program comprises constraints associated with multiple days. At step 304, the processor 202 determines for one of the multiple days a further fleet configuration candidate based on an output of solving the linear problem. At step 306, the processor 202 adds the further fleet configuration candidate to the multiple fleet configuration candidates by including an additional corresponding column into the linear program. At step 308, the processor 202 repeats the steps of solving the linear program, determining a further fleet configuration candidate and adding the further fleet configuration candidate to the multiple fleet candidates until a termination condition is met. At step 310, in response to the termination condition being met, the processor 202 outputs the selected one of multiple fleet candidates as the optimised fleet configuration.

In this disclosure, the demand can be determined based on historical data or forecasted data, and the linear program can comprise columns representing the number of each type of vehicle in a potential fleet. An efficiency measure can capture both the operation costs, e.g., driver wages and fuel consumption, and the fixed costs, e.g., acquisition and maintenance of the vehicles. As such, the fleet design problem lies at the intersection between the tactical and operational decision levels.

Note that, unless specified otherwise in this disclosure, vehicle routing problems represent delivery scenarios to be carried out in a single unit of time. Normally, such unit of time is the working day. For this reason, in the following disclosure, the term day can be understood to refer to the more general concept of suitable unit of time. Other units of time may be hours, weeks, months or years. Vehicles may include land-based, airborne or watercraft, such as cars, trucks, ships, airplanes, helicopters, autonomous drones etc. In one example, the drones are instructed to deliver the goods autonomously according to the selected configuration of the drone fleet.

Fleet design may be considered as an extension of the classic vehicle routing problem where the fleet composition is not an input to the problem, but a decision to be made. Such extensions are called fleet size and mix vehicle routing problems (FSMVRP) and, due to their huge search space, are much harder to solve than their VRP counterpart. For this reason, it is difficult to extend the applicability of FSMVRPs beyond considering a single representative day's demand data or not-so-rich VRP variants, making them unsuitable to capture the complexity of real-world supply chains.

In particular, single-day scenarios cannot describe situations in which the demand can change significantly from day to day, and simplistic VRP extensions do not have the constraint richness to capture the requirements of a heterogeneous set of clients.

Nevertheless, such formulations can be used to optimise some real-world applications that exhibit regularity in the input data, such as mail delivery or waste collection. Moreover, rich single-day FSMVRP formulations can be used as sub-components in wider optimisation schemes.

Scalability may be an issue where the whole multi-day problem has to be solved at once in order to guarantee that, on each day, a subset of the same fleet of vehicles is used, Given that the single-day problem is already NP-hard, solving the multi-day variant for long planning horizons, e.g., one year, is intractable. Generality may be an issue because, in order to keep the horizons shorts, a problem-specific pre-processing technique cannot be easily extended to arbitrary VRP variants, especially when time constraints are present. Another issue concerns the efficiency of a fleet; by dropping the requirement of serving all the demand using owned vehicles, companies can achieve a much greater vehicle usage, a measure of fleet efficiency.

A general and scalable technique to synthesise efficient fleet configurations from historical or forecasted demand data is disclosed herein. Rich FSMVRP solvers are called by processor 202 to solve the sub-problems in a column generation scheme, thus factoring away the complexity of the rich VRP variant at hand, which is invisible to the solver. The effectiveness of this approach is discussed for two different rich vehicle routing engines based on real-world demand data. These engines involve rich vehicle routing variants that can be considered to represent a long-haul.

In one example, the invention is used for optimising the costs of acquiring and running a fleet of vehicles over a long planning horizon, e.g., one year, while guaranteeing the necessary level of service to satisfy the demand of all customers. This requires taking into account both fixed costs (Capital expenses or CAPEX), e.g., acquisition and maintenance expenses, as well as operational costs (Operational expenses or OPEX), e.g., fuel and drivers' wages.

More formally, let I be the set of days, or horizon, that is being considered, and T be the set of all available vehicle types. Each vehicle type t∈T has a fixed cost bₜ, which may aggregate, for instance, acquisition and maintenance costs. On each day, i∈I should satisfy the demand of a set of customers while respecting a rich set of constraints, e.g., time windows, pickup and delivery, compartments, or vehicle-commodity compatibilities, etc. The rich vehicle routing problem with a known fleet for day i∈I is denoted as VRP(i), and FSMVRP(i) denotes the corresponding fleet size and mix problem. The fleet design approach can be applied to a rich vehicle routing problem, regardless of the complexity of the involved constraints, as long as a suitable solver for FSMVRP(·) is available. That is, the FSMVRP(·) solver must exactly or approximately solve the FSMVRP problem for a single clay while honouring the requested upper and lower bounds on the number of vehicles of each type t∈T.

An optimal fleet is considered to be a fleet that minimises the sum of fixed and operation costs across the whole horizon. A method to achieve this is described in more detail below.

Given VRP(i), i∈I a set Nᵢ of possible fleets that can be used to solve VRP(i). Nᵢ can be considered to be options (or candidates) for i. The selected candidate for each day will be, in general, different. Moreover, if it is assumed that all the vehicles in the option must be used, the number of options will also be finite. rᵢⱼ is a cost coefficient that denotes the cost of operating the fleet j∈Nᵢ of day i∈I optimally. rᵢⱼ is calculated by the processor excluding any fixed costs (bₜ), but including any possible vehicle-specific coefficients, e.g., fuel cost per kilometre, hourly driver wage, etc. For every day i∈I, every option j∈Nᵢ can be represented as a vector of length |T| specifying how many vehicle of each type are used. Fᵢⱼ^{t} denotes the number of vehicles of type t∈T used by option j for day i.

For each option j∈N, in each day i∈I, a binary decision variable dᵢⱼ represents whether a particular option is actuated or not. The integer decision variables Fₜ represent, for each t∈T, the number of vehicles of type t∈T that are part of the overall fleet.

The following model [M] is solved by the processor to minimise the sum of the fixed (bₜ) and operation (rᵢⱼ) costs of the fleet across the whole planning horizon:

$$\begin{matrix}[ M ] minimise {\sum }_{i} {F}_{i} {b}_{i} + {\sum }_{i , j} {r}_{ij} {d}_{ij} & ( 1 ) \\ subjectto {\sum }_{j} {d}_{ij} = 1 ∀ i ∈ I & ( 2 ) \\ {\sum }_{j} {F}_{ij}^{i} {d}_{ij} \leq {F}_{t} ∀ i ∈ I , t ∈ T & ( 3 ) \\ {F}_{i} \geq 0 , integer ∀ t ∈ T & ( 4 ) \\ {d}_{ij} ∈ \{ 0 , 1 \} ∀ i ∈ I , j ∈ {N}_{t} & ( 5 )\end{matrix}$$

Constraints (2) means only one option can be selected by the processor for each day. Constraints (3) ensures that the overall fleet selected by the processor has enough vehicles of type t to actuate the chosen option for every day. Constraints (4) and (5) enforce the integrality of the solution determined by the processor.

Note that, provided that dᵢⱼ is positive, Constraints (2) implies dᵢⱼ≦1. Therefore, Constraints (5) can be replaced in the model with dᵢⱼ≧0, integer. However, dᵢⱼ is binary in the model shown above to stress its semantics as binary choice.

Every coefficient rᵢⱼ in constraint (1) is generated by the processor by solving the corresponding VRP(i), i∈I using the fleet j∈Nᵢ. Each one of these VRP(·) is NP-hard, moreover the number of days |I| can be quite large, e.g., one or more years, and the number of possible options |Nᵢ| is exponential in |T|. As a consequence, even if solving the linear relaxation of the model [M] is relatively easy, obtaining all the necessary coefficients rᵢⱼ is difficult. A column generation approach is described below which can be implemented by the processor to address this issue. As the model [M] contains integrality constraints, and integrality is not automatically guaranteed in this case, a branch & bound scheme is executed by the processor through which the variables Fₜ and dᵢⱼ are set to integer values. The FSMVRP(·) should support lower and upper bounds on the number of vehicles. The processor executes a branch & bound tree search where column generation is used at each node to provide lower bounds. This type of approach is referred to as a branch & price approach.

The column generation technique is disclosed in general terms below, followed by steps to execute it via the processor with respect to the model [M].

Column generation is a technique for solving linear programs where the number of variables, or equivalently columns, is intractable or hard to enumerate. The approach exploits the idea that only a small number of variables are needed to determine the optimal solution, as most of them will assume value zero.

Column generation in general relates to an approach where the method starts with a small subset of columns and adds columns until a good solution is found. For example, the problem spans two days and processor 202 starts with two fleet configuration candidates. Therefore, there are four selection variables d₁₁, d₁₂, d₂₁, d₂₂, where dᵢⱼ=1 indicates that fleet i is chosen on day j. The cost function would include

$${\sum }_{i , j} {r}_{ij} {d}_{ij}$$

where rᵢⱼ, is the cost of operating fleet i on day j. Again, there are four cost parameters rᵢⱼ. A constraint could be

$${\sum }_{j} {d}_{ij} = 1$$

for i=1 and i=2, which means only a single fleet candidate can be selected for one day. In matrix form, the constraint can be written as

$$[ \begin{matrix}{d}_{11} & {d}_{12} \\ {d}_{21} & {d}_{22}\end{matrix} ] [ \begin{matrix}1 \\ 1\end{matrix} ] = [ \begin{matrix}1 \\ 1\end{matrix} ] .$$

If a new candidate configuration is added to the problem, which means processor 202 can select from three different options, the matrix would have three columns for the additional selection variables d₁₃, d₂₃. This is why the proposed approach is called column generation. Each column refers to the set of variables dᵢⱼ, and potentially parameters rᵢⱼ that are included in the problem. It is noted here that column does not necessarily have to be a column vector but could be a row vector as long as its function is that of a set of variables and parameters that are included into the problem.

The problem can be decomposed into a master problem and a sub problem that are solved by the processor. The master problem is a linear program where at each iteration the processor only considers a restricted number of variables and solves the master problem to optimality. The sub-problem is an artificially defined problem that the processor uses to identify which new variables, or equivalently columns, are to be added to the master problem (linear program) in the next iteration. Each column comprises a potential new fleet, represented as the number of each vehicle type, and the cost coefficient of the column is the operation costs associated with that fleet, as determined by the FSMVRF engine. The objective function of the sub-problem is the reduced cost of the new columns with respect to the optimal dual variables of the current optimal master solution. The constraints in the sub-problem ensure that a solution is indeed a valid column in the master problem. This phase is commonly referred to as pricing of columns. If the processor identifies a column with negative reduced cost, the processor adds it to the master and proceeds to the next iteration, otherwise the processor considers a termination condition to be met and stops the process. Adding a column to the master problem may comprise modifying a data structure stored on data memory 206 that contains the variables and parameters of the linear problem, such as by calling a “linearProblemMatrix.append(newColumn)” function on the linear problem matrix.

One aspect in the implementation of a column generation scheme, is to recognise the structure of the sub-problem, and to identify a problem-specific technique to solve it efficiently. For instance, when solving the cutting stock problem, a classical domain of application for column generation, the sub-problem can be seen a knapsack problem, which allows to solve it efficiently using dynamic programming.

### Sub-Problem

In order to apply column generation to the problem of fleet design processor 202 processes the linear relaxation of [M], where pᵢ and qₜᵢ denote the dual variables of Constraints 2 and 3, respectively.

The reduced cost of a variable dₜᵢ is then

$${r}_{ij} + {\sum }_{t} {F}_{ij}^{t} {q}_{ti} - {p}_{i} .$$

The sub-problem is solved with the aim of generating a column with negative reduced cost. Each column is uniquely identified by rᵢⱼ and the Fᵢⱼ^{t}s, which represent variables of the sub-problem. Ignoring the term pᵢ which is a constant in this context, it is observed that the reduced cost is exactly the objective of a FSMVRP where the fixed costs of the vehicles are represented by the qₜᵢs. The rᵢⱼ represents the cost of optimally operating the fleet, which is determined by the Fᵢⱼ^{t}s variables.

Since the FSMVRP is NP-hard, it is difficult to optimally solve the sub-problem efficiently. To overcome this issue, processor 202 calls a heuristic FSMVRP solver. Such a solver allows good quality solutions to be obtained for the sub-problem in a short time. The choice of the underlying solver does not affect the validity of the approach disclosed herein. This is considered to be a strength of this approach, because it allows the processor to attempt to solve any rich vehicle routing variant, as long as a solver is available. Examples software systems that can solve the FSMVRP are Decartes, Routist and JSpirit, as well as the Google Optimization Tools. There are also many bespoke solvers built for customers with special needs.

The solving via the processor of the sub-problem needs to provide a column with negative reduced cost, but not necessarily the optimal one. The heuristic could (and often will) produce a column with non-optimal objective value rᵢⱼ. Conceptually this is not a problem, as the processor can just insert the newly determined column in the master problem and carry on with the column generation process. The master problem can be seen as a separated entity from the sub-problems. The role of the master problem is to determine days where the fleet could be reduced or changed to further reduce the total cost and provide a new fixed cost for that day (the dual variables qₜᵢ). This could be seen as an heuristic with a mathematical linear problem at its core. In testing, the use of column generation performed well and enabled the processor to tackle problems with large horizons and rich underlying VRPs.

Below is the dual of the linear problem denoted as [D].

$$[ D ] maximise {\sum }_{i} {p}_{i}$$

$$subjectto {\sum }_{i} {q}_{ti} \leq {b}_{t} ∀ t = 1 , … , T$$

$${p}_{i} - {\sum }_{t} {F}_{ij}^{t} {q}_{ti} \leq {r}_{ij} ∀ i ∈ I , j ∈ {N}_{i} .$$

The dual problem “distributes” the costs bₜ over the days so to maximise the total cost. pᵢ acts as a lower bound on all possible costs for day i. The variables qₜᵢ can indicate how much a vehicle of type t is worth on day i.

### Prior Fleet

Further to the above method, the problem of designing a fleet given that some vehicles are owned is considered, i.e., a prior fleet. This scenario is important as most companies facing a fleet design problem already own a fleet, and they might want to adjust it to accommodate changes in the predicted future demand. The introduction of a prior fleet can change the problem considerably.

The problem now is to determine how to modify the existing fleet in order to meet the demand. Two possible ways of doing so are considered: buying vehicles and selling vehicles (replacing vehicles can be seen as selling a vehicle and buying another one). This requires extending the previous model [M] to include the revenue from selling a vehicle, and the existence of a prior fleet (whose acquisition cost is zero).

Eₜ, t∈T denotes the number of vehicles of type tin the prior fleet. The decision variables Fₜ⁺ are introduced to represent the additional vehicles of type t that need to be bought, and Fₜ⁻ represents the owned vehicles of type t that need to be sold. The coefficients sₜ represent the revenue from the sale of a vehicle of type t. The model [E] to be solved by the processor follows.

$$\begin{matrix}[ E ] minimise {\sum }_{t} {F}_{t}^{+} {b}_{t} - {\sum }_{t} {F}_{t}^{-} {s}_{t} + {\sum }_{i , j} {r}_{ij} {d}_{ij} \\ subjectto {\sum }_{j} {d}_{ij} = 1 ∀ i ∈ I & ( 6 ) \\ {\sum }_{j} {F}_{ij}^{t} {d}_{ij} \leq {F}_{t}^{+} - {F}_{t}^{-} + {E}_{t} ∀ i ∈ I , t ∈ T & ( 7 ) \\ {F}_{t}^{-} \leq {E}_{t} ∀ t ∈ T & ( 8 ) \\ {F}_{t}^{+} , {F}_{t}^{-} \geq 0 , integer ∀ t ∈ T & ( 9 ) \\ {d}_{ij} ∈ \{ 0 , 1 \} ∀ i ∈ I , j ∈ {N}_{i} & ( 10 )\end{matrix}$$

Constraints (7) ensure that the overall fleet, i.e., the right-hand side of the constraint, covers the selected option j for day i. Constraints (8) mean that only vehicles that are already owned can be sold. Constraints (9) are additional integrality constraints for the newly added variables.

Note that if sᵢ>bᵢ the model is unbounded, however this would reflect a meaningless situation in the real world, in which the return from selling a vehicle is higher than the cost of buying the same vehicle. Moreover, if sᵢ≦bᵢ there is an optimal solution in which, for every t, only one of Fₜ⁺ and Fₜ⁻ can be non-zero.

Note that, while the master is now different, the sub-problem is unchanged, and therefore all the properties of the base model still hold.

### Extension: Hiring Options

Designing a fleet that guarantees the satisfaction of the demand of all customers across the whole planning horizon might not be efficient. Even the most streamlined fleet can include vehicles that will be only used on a few days of high demand, and that will be idle the rest of the time. A solution to this problem is to settle on a fleet that does not guarantee to satisfy the demand on all days, but compensate this limitation through hiring of vehicles. The model can be straightforwardly extended to consider hiring options. To do so, the following additional variables and coefficients are introduced: Hₜᵢ is the number of vehicles of type t hired on day i, hₜᵢ is the cost of hiring a vehicle of type t on day i, which can be different from day to day.

An option is now represented uniquely by [symbol] Fᵢⱼ^{t}, Hᵢⱼ^{t} [symbol] , t∈T, which therefore includes both owned vehicles and hired vehicles for that option on that day. The extended model [H] to be solved by the processor follows.

$$\begin{matrix}[ H ] minimise {\sum }_{t} {F}_{t}^{+} {b}_{t} - {\sum }_{t} {F}_{t}^{-} {s}_{t} + {\sum }_{t , i} {H}_{ti} {h}_{ti} + {\sum }_{i , j} {r}_{ij} {d}_{ij} \\ subjectto {\sum }_{j} {d}_{ij} = 1 ∀ i ∈ I & ( 11 ) \\ {\sum }_{j} {F}_{ij}^{t} {d}_{ij} \leq {F}_{t}^{+} - {F}_{t}^{-} + {E}_{t} ∀ i ∈ I , t ∈ T & ( 12 ) \\ {\sum }_{j} {H}_{ij}^{t} {d}_{ij} \leq {H}_{ti} ∀ i ∈ I , t ∈ T & ( 13 ) \\ {F}_{t}^{-} \leq {E}_{t} ∀ t ∈ T & ( 14 ) \\ {F}_{t}^{+} , {F}_{t}^{-} , {H}_{ti} \geq 0 , integer ∀ t ∈ T & ( 15 ) \\ {d}_{ij} ∈ \{ 0 , 1 \} ∀ i ∈ I , j ∈ {N}_{i} & ( 16 )\end{matrix}$$

With respect to model [E], the additional Constraints (13) make sure that the hired vehicles of type t on day i cover the required hired vehicles of type t in the selected option j. Constraints (15) are the additional integrality constraints for the newly added variables Hₜᵢ.

Denoting the dual variables of Constraint (13) as wₜᵢ, the reduced cost of variables dᵢⱼ becomes

$${r}_{ij} + {\sum }_{t} {q}_{ti} {F}_{ij}^{t} + {\sum }_{t} {w}_{ti} {H}_{ij}^{t} - {p}_{i} . \qquad ( 17 )$$

This can be interpreted as the objective of a FSMVRP where the hired vehicles are considered as a different vehicle types. As such, they can have different operation costs, and this source of complexity is once again handed over to the chosen underlying solver.

### Alternative Model

The above model represents a rather simple extension of [E]. However, considering each hired vehicle as a different vehicle type considerably increases the size of the search space for the processor to consider. Since the original sub-problem is already a very hard problem by itself, an alternative model is presented which does not further increase its complexity.

This formulation focuses on route generation rather than fleet generation. The central idea behind this second model is that a hired vehicle of type t∈T and an owned vehicle of the same type can perform the same tasks, only the cost is different. Therefore, the processor can first solve [E] to produce the optimised fleet options and, in a second step, determine which vehicles (forming an option) to buy and which ones to hire. The processor can also consider the routes generated as a byproduct of the resolution of [E]'s sub-problems, and assign a hired or owned vehicle to each route. The processor is not restricted to use only the previously generated routes; indeed, the second model presented below can be used in a column generation process, to determine additional routes that can improve on the previously generated routes.

A new notation is used for the second model. C, denotes the set of all customers to be visited on day i∈I. For every vehicle type t∈T and day i∈I, Rᵢ^{t} denotes the set of all the feasible routes for a vehicle of type t on day i. For every route r∈Rᵢ^{t} and customer c∈Cᵢ, a continuous coefficient a_{rc} is introduced modelling which fraction of the demand of customer c is delivered though route r. The fact that a_{rc} is continuous and can be used to solve for split deliveries. For every route r∈Rᵢ^{t}, we denote by cᵣ^{o} the cost of operating an owned vehicle of type t on day i, and by cᵣ^{h} the cost of operating a hired vehicle of type t on the same day. The new binary variables xᵣ^{o} and xᵣ^{h} represent whether route r is actuated with an owned vehicle or a hired vehicle, respectively. An unused route will have xᵣ^{o}xᵣ^{h}=0 otherwise only one of xᵣ^{o} and xᵣ^{h} will be non-zero in the optimal solution. The model [R] to be solved by the processor follows.

$$\begin{matrix}[ R ] minimise {\sum }_{t} {F}_{t}^{+} {b}_{t} - {\sum }_{t} {F}_{t}^{-} {s}_{t} + {\sum }_{t , i} {H}_{ti} {h}_{ti} + {\sum }_{i , t} {\sum }_{r ∈ {R}_{i}^{t}} ( {c}_{r}^{o} {x}_{r}^{o} + {c}_{r}^{h} {x}_{r}^{h} ) \\ subjectto {\sum }_{r ∈ {R}_{i}^{t}} {x}_{r}^{o} \leq {F}_{t}^{+} - {F}_{t}^{-} + {E}_{t} ∀ i ∈ I , t ∈ T & ( 18 ) \\ {\sum }_{r ∈ {R}_{i}^{t}} {x}_{r}^{h} \leq {H}_{ti} ∀ i ∈ I , t ∈ T & ( 19 ) \\ {\sum }_{t} {\sum }_{r ∈ {R}_{i}^{t}} {a}_{rc} ( {x}_{r}^{o} + {x}_{r}^{h} ) = 1 ∀ i ∈ I , c ∈ {C}_{i} & ( 20 ) \\ {F}_{t}^{-} \leq {E}_{t} ∀ t ∈ T & ( 21 ) \\ {F}_{t}^{+} , {F}_{t}^{-} , {H}_{ti} \geq 0 , integer ∀ t ∈ T & ( 22 ) \\ {x}_{r}^{o} , {x}_{r}^{h} ∈ \{ 0 , 1 \} ∀ i ∈ I , j ∈ {N}_{i} & ( 23 )\end{matrix}$$

Constraint (18) ensures that enough vehicles are owned of type t to cover the selected routes on day i performed by owned vehicles of type t. Similarly, Constraint (19) ensures that there are enough hired vehicles. Constraint (20) requires that all the demand of a customer c be satisfied. Model [R] provides a multi-day extension of route generation approaches.

Denoting with zᵢₜ^{o} and zᵢₜ^{h} the dual variables of Constraints (18) and (19), and with y_{ic} the dual variables for Constraints (20), the reduced cost for xᵣ^{o} is determined via:

$${c}_{r}^{o} - {\sum }_{c ∈ {C}_{t}} {a}_{rc} {y}_{ic} + {z}_{it}^{o} .$$

This is equivalent to a rich TSP with profitability, in which not all customers need to be visited, but for each visited customer c a positive constant y_{ic} is subtracted from the objective. Once again, the processor can solve this problem with an off-the-shelf rich VRP solver, in which an owned vehicle of type t is used. The reduced cost of xᵣ^{h} and its interpretation are analogous.

### Implementation Details

In this section of the disclosure, details of the implementation of the models are explaining, and how some issues are addressed that arise when implementing column generation approaches and new issues originating from the fact that the sub-problems are not being solved to optimality.

### Branching Strategy

In a branch & price scheme a branching strategy is chosen such that the sub-problem structure is preserved. Once the linear relaxation of the root node is solved, a variable Fₜ (which could be fractional) is chosen and is branched on by imposing for example Fₜ≦Mₜ and Fₜ≧Mₜ+1 where Mₜ is defined as └Fᵢ┘ if F_{f} is fractional or └Fₜ┘−1 if Fᵢ is integer. Adding this type of constraint to the master problem does not affect the problem structure, and constitutes additional information that can be passed to the underlying FSMVRP(·) solver. The maximum number of vehicles of type t∈T can be bounded by considering Mᵢ+1 free vehicles of type t.

It is noted that when the heuristic solver is executed by the processor, it might find the same column (fleet option) multiple times with a higher or lower routing cost. If the cost is lower, the processor can replace the existing column with the newly found column, otherwise the processor can discard the newly found column. The solution of the master problem at the root node may not be guaranteed to be optimal and therefore not guaranteed to be a lower bound. The heuristic solver might have missed one or more solutions which would have further decreased the objective. Therefore at some point in the branching tree the processor might find a node which has a better linear (and even integer) objective than the root node's linear objective. This may happen in practice due to the use of a heuristic solver. The reason is that the branching constraints force the underlying solver to look in parts of the search space that were previously missed. From this perspective, the branching procedure adds strength to the algorithm by suggesting the exploration of different parts of the search space. From an algorithmic point of view this does not represent an issue and, in fact, it strengthens the performances of the method.

For the sake of clear explanation, the heuristic is considered as an exact method, in order to analyse the algorithm hereinafter.

### Initialisation

In model [M], provided that at least one option exists for each day, the problem is always feasible. Therefore, the problem can be initialised by the processor by finding a first option for each day. For example the processor can execute the underlying FSMVRP(·) solver to find the first option that generates the best routing option. In practice, the processor solves for each day by assuming that all the vehicle types are unlimited and that the acquisition cost is zero. Therefore, the processor can record that that option will have the best routing cost possible for that day. The processor can use this solution during the sub-problem selection and the lower bound computation, as explained later in the section. Note that this is not the only option, as other methods could be used by the processor to initialise the solver.

### Number of Solved Sub-Problems at Each Step

In some applications of the method, a high number of sub-problems have to be solved, for example, when the method is applied to long term scenarios the number of days (sub-problems) can be in the hundreds.

Solving the sub-problems is the most computationally expensive part of the algorithm. Simulations show that it often amounts to 99.9% of the total run time. On the contrary, the solution of the master problem, integer or linear, is almost instantaneous. Therefore, the number of columns inserted in the master problem is not of particular concern. It is difficult to solve All sub-problems at every iteration in a reasonable time, and therefore the processor chases amongst some of the sub-problems. To address this, the processor ranks the sub-problems and solves only a fraction of them (for example, 15 to 20) following a cyclic order until one column with negative reduced cost is determined. Not all the days have the same impact on the final solution. Therefore, there will be some days that are easy to accommodate with a different fleet and other that require more work.

There are many possible ways of ranking the days. For example, the processor can rank the days based on the dual variables. If the processor determines that qₜᵢ=0∀t∈T for a given day i∈I, then the processor can skip solving of the sub-problem for this day, since the solution found in the initialisation phase is already the best (assuming the heuristic finds the best) and its reduced cost its zero. Moreover, the processor can avoid solving a sub-problem similar to one which it has solved before. For example, if the dual variables qₜᵢ are similar to a previous iteration where the processor solved the same day, the processor skips solving for the day in the current iteration. To rank the days, the processor determines a weighted total variation. For example, the processor selects a day i∈I and considers all the options j∈Nᵢ that the processor has determined so far. qₜᵢ^{j} denotes the dual variables that were used when the processor determined option j. |Fᵢⱼ| denotes the total number of vehicles in option j. The score or rank of a day is then determined by the processor via the following equation:

$${\sum }_{j} {\sum }_{t} {( {q}_{ti} - {q}_{ti}^{j} )}^{2} \frac{{F}_{ij}^{t}}{\vert {F}_{ij} \vert} .$$

The processor determines the total variation with respect to the variables qₜᵢ^{j} weighted by the importance that vehicle type t had in the found option. The number of sub-problems that the processor solves at each iteration can be set equal to the degree of parallelism (independent cores or virtual cores) of the processor or other hardware on which the method is executed.

The ranking can be crucial to the execution time of the method. Such a ranking system has not been found in any study on sub-problem selection in the prior art literature.

### Oscillations, Degeneracy and Early Termination

Two recurring issues in column generation are the tailing off effect and the oscillating behaviour of the dual variables.

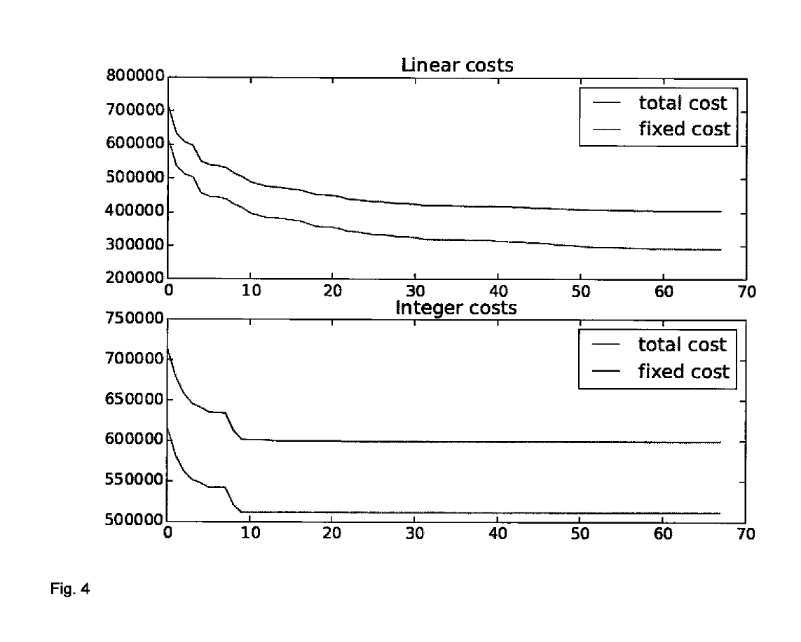

Oscillations can be considered to be a part of the optimisation process. Indeed, in testing as can be observed in FIG. 4, which shows the total objective and relative fixed cost for both integer and linear restricted master problems plotted against the progression of iterations, in the first phase the objective decreases quickly, indicating that oscillations are needed to find alternative solutions. The dual variables indicate which vehicle type in which days have to be drastically decreased or can be increased.

A more pronounced behaviour is the tailing off effect. In FIG. 4, it can be observed how in the last iterations the objective decreases slowly. This can be explained observing that significant decreases in the fixed cost correspond to significant decreases in the total cost. In the last phase, the columns determined by the processor have negative reduced costs close to zero, causing small or possibly null improvement in the objective. This is due to different fleets having almost identical routing costs. Therefore the solutions determined by the processor in the final stages only decrease the routing cost by a very small amount. Coherently, the primal problem presents high degeneracy and many equivalent solutions, as for small days many different options can be chosen without worsening or improving the objective. For these reasons, The processor can solve the dual problem when the primal problem is degenerate. The processor also determines whether an early termination is met to stop the tailing off effect. For example, if for 5 consecutive iterations the processor determines insufficient changes in the fleet composition and in the the objective, the processor prematurely stops the process at the current node. Experiments performed with the method show that in this case the benefit of continuing the column generation process until completion is not significant. Therefore, once the branch & price scheme is over, even if the best node found was early terminated we does not continue execution of the process.

### Lower Bounds

Good lower bounds can enhance the performance of the branch & bound search. The processor can use a modification of a Lagrangian relaxation to determine a lower bound.

For example, given a node in the search tree, z and z̅ denote the optimal value of the linear and integer master problem, respectively. Similarly, z_{RMP} and z̅_̅{̅R̅M̅P̅}̅ denote the optimal objectives of the current restricted master problem. rcᵢ^{o} denotes the reduced cost of the exact solution of sub-problem i obtained using the current dual variables. The standard lower bound, can then be determined by the processor via the Lagrangian relaxation, as

$${z}_{RMP} + {\sum }_{i} {rc}_{i}^{*} \leq z \leq \overline{z} .$$

In line with previous assumptions, the processor determines the solution with the heuristic to be the optimal one. Even with that assumption, every sub-problem should be solved to optimality in order to apply the above bound. If the processor does not do this, there can be a further lower bound on the days that the processor did not solve at the current iteration. As explained earlier, the days with qₜᵢ=0∀t∈T have zero reduced cost. Consider a day i that the processor did not solve and that has a positive dual variable. The processor is then searching for the option j that minimises

$${rc}_{i}^{*} = {r}_{ij} + {\sum }_{t} {q}_{ti} {F}_{ij}^{t} - {p}_{i} .$$

To further lower bound this quantity, note that any fleet for day i satisfies the constraint

$${\sum }_{t} {c}_{t} {F}_{ij}^{t} \geq {TD}_{i}$$

where cᵢ is the capacity of vehicle type t and TDᵢ is the total demand of day i. Consequently

$${rc}_{i}^{*} \geq {r}_{i 0} + min \{ {\sum }_{t} {q}_{ti} {F}_{t} : {\sum }_{t} {c}_{i} {F}_{ij}^{t} \geq {TD}_{i} \} - {p}_{i} = {tc}_{i} .$$

The numbers rcᵢ , are relatively easy for the processor to calculate. S denotes the set of days i that that the processor solved in the pricing phase and set rcᵢ=0 if i is such that qₜᵢ=0∀t∈T. The processor can therefore validly and quickly compute the lower bound via the following equation:

$${z}_{RMP} + {\sum }_{i ∈ S} {rc}_{i}^{*} + {\sum }_{i ∈ {S}^{C}} {rc}_{i} \leq z \leq \overline{z} .$$

With this lower bound the processor can perform the branch & bound search efficiently, which increases performance and reduces computation time and/or allows solving larger problems than what has been possible previously.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A transport system, the transport system comprising:
one or more sender warehouses storing goods at respective sender locations;
multiple receiver warehouses for storing the goods at respective receiver locations;
a data collection server to receive demand data for multiple days, convert the demand data into a data format suitable for one of multiple vehicle routing engines, and store the demand data on a datastore;
a communication network to transmit the demand data from the data collection server to a processing server;
a processing server to retrieve the demand data and to determine an optimised fleet configuration comprising a number and type of vehicles based on the demand data for multiple days, the processing server comprising a linear program solver and the one of multiple vehicle routing engines, the processing server being configured
to activate the linear program solver to optimise a cost value by selecting one of multiple fleet configuration candidates that meet a transport demand represented by the demand data, the linear program comprising constraints associated with multiple days;
to activate the one of multiple vehicle routing engines to determine based on the demand data in the suitable data format for one of the multiple days a further fleet configuration candidate based on an output of the linear program solver;
to add the further fleet configuration candidate to the multiple fleet configuration candidates by including an additional corresponding column into the linear program;
to repeat the steps of solving the linear program, determining a further fleet configuration candidate and adding the further fleet configuration candidate to the multiple fleet candidates until a termination condition is met; and
a fleet of vehicles according to the selected one of multiple candidate fleet configurations to transport the goods from the sender locations to the receiver locations according to the demand data.

2. A computer implemented method for determining an optimised fleet configuration, the method comprising:
solving a linear program to optimise a cost value by selecting one of multiple fleet configuration candidates comprising a number and type of vehicles that meet a transport demand at minimum cost, the linear program comprising constraints associated with multiple days;
determining for one of the multiple days a further fleet configuration candidate based on an output of solving the linear problem;
adding the further fleet configuration candidate to the multiple fleet configuration candidates by including an additional corresponding column into the linear program;
repeating the steps of solving the linear program, determining a further fleet configuration candidate and adding the further fleet configuration candidate to the multiple fleet candidates until a termination condition is met; and
in response to the termination condition being met outputting the selected one of multiple fleet candidates as the optimised fleet configuration.

3. The method of claim 2, wherein the method further comprises performing column generation comprising a master problem and a sub-problem, the linear program being the master problem and determining for one of the multiple days a further fleet configuration candidate being the sub-problem.

4. The method of claim 2, wherein determining for one of the multiple days a further fleet configuration candidate comprises determining a fleet configuration that solves a vehicle routing problem for the one of the multiple days.

5. The method of claim 2, wherein determining for one of the multiple days a further fleet configuration candidate comprises determining a cost coefficient for the further fleet configuration candidate.

6. The method of claim 5, wherein determining the cost coefficient comprises optimising a reduced cost associated with the further fleet configuration candidate.

7. The method of claim 5, wherein the linear problem comprises the cost coefficient of the further fleet configuration candidate.

8. The method of claim 2, wherein the output of solving the linear problem is a value of a dual variable of the linear problem.

9. The method of claim 8, wherein the dual variable of the linear problem is indicative of the costs of the vehicles.

10. The method of claim 2, wherein the linear problem comprises constraints to meet the transport demand.

11. The method of claim 2, where the linear problem comprises a binary decision variable for each fleet configuration candidate indicative of whether that fleet configuration candidate is selected.

12. The method of claim 2, wherein each of the multiple fleet configuration candidates comprise a number of vehicles for each of multiple vehicle types.

13. The method of claim 2, wherein the linear problem comprises one or more columns associated with vehicles in a prior fleet and one or more columns associated with buying vehicles or selling vehicles or both.

14. The method of claim 2, wherein the linear problem comprises one or more columns associated with hiring vehicles on one or more of the multiple days.

15. The method of claim 2, wherein determining the further fleet configuration candidate comprises determining a routing of vehicles that meets a demand for the further fleet configuration candidate.

16. The method of claim 15, wherein the method further comprises determining for each route whether to buy or hire a vehicle for that route.

17. The method of claim 15, wherein determining the routing and repeating the step of determining a further fleet configuration candidate comprises determining multiple routings for respective fleet configuration candidates and the method further comprises selecting one of the multiple routings based on the selected one of multiple fleet candidates.

18. The method of claim 2, wherein determining the further fleet configuration candidate comprises performing a branch and price method.

19. The method of claim 18, wherein the branch and price method branches on a number of vehicles for each of multiple vehicle types.

20. The method of claim 2, wherein determining for one of the multiple days a further fleet configuration candidate comprises selecting the one of the multiple days based on a score for each of the multiple days.

21. The method of claim 20, wherein the score for each of the multiple days is based on a dual variable of the linear program.

22. The method of claim 2, wherein determining for one of the multiple days a further fleet configuration candidate comprises activating one of multiple routing engines.

23. A non-transitory computer readable medium that has an executable program stored thereon that when executed causes a computer to perform the method of claim 2.

24. A computer system for determining an optimised fleet configuration, the computer system comprising:
an input port to receive a transport demand for each of multiple days;
a processor
to solve a linear program to optimise a cost value by selecting one of multiple fleet configuration candidates comprising a number and type of vehicles that meet the transport demand, the linear program comprising constraints associated with multiple days,
to determine for one of the multiple days a further fleet configuration candidate based on an output of solving the linear problem,
to add the further fleet configuration candidate to the multiple fleet configuration candidates by including an additional corresponding column into the linear program, and
to repeat the steps of solving the linear program, determining a further fleet configuration candidate and adding the further fleet configuration candidate to the multiple fleet candidates until a termination condition is met; and
an output port to output the selected one of multiple fleet candidates as the optimised fleet configuration in response to the termination condition being met.
